(19) United States
(12) Patent Application Publication
(10) Pub. No.: US 2015/0347974 A1
(43) Pub. Date: Dec. 3, 2015

(54) MULTI-OBJECTIVE RECRUITER SEARCH

(71) Applicant: LinkedIn Corporation, Mountain View, CA (US)

(72) Inventors: Shakti Dhirendraji Sinha, Sunnyvale, CA (US); Asif Mansoor Ali Makhani, Fremont, CA (US); Anmol Bhasin, Los Altos, CA (US); Senthil Sundaram, South San Francisco, CA (US); Viet Thuc Ha, Milpitas, CA (US)

(21) Appl. No.: 14/595,354

(22) Filed: Jan. 13, 2015

Related U.S. Application Data
(60) Provisional application No. 62/004,730, filed on May 29, 2014.

(51) Int. Cl. G06Q 10/10; G06Q 50/00

(52) U.S. Cl. CPC G06Q 10/1053; G06Q 50/01

(57) ABSTRACT

A system includes a database, a network interface, and a processor. The database includes, for each multiple users of a social network, profile data and activities, by the user, related to the social network. The network interface is configured to be communicatively coupled to user devices associated with the population of users. The processor is configured to obtain a recruitment search query for a position in an organization, compare the recruitment search query against the profile data of at least some of the users to obtain a comparison, determine, for each of the at least some of the users, a likelihood of interacting with a recruiter associated with the position based on the activities of each of the at least some of the users, and transmit, to at least one of the users, a communication related to the position based, at least in part, on the comparison and the likelihood of interacting.

### PRIORITY

This application claims the benefit of priority to U.S. Provisional Patent Application No. 62/004,730, filed May 29, 2014, which is incorporated herein by reference in its entirety.

### TECHNICAL FIELD

The subject matter disclosed herein generally relates to multi-objective optimization for recruiter searching.

### BACKGROUND

Recruiters for a variety of purposes, including job recruiters, may utilize social networks to identify candidates for a position. Conventionally, recruiters may scan through social network profiles and compile a list of prospects. The recruiters may then contact some or all of the prospects with information about the position using one of several communications media. Prospects who reply to the communication may then enter a normal recruitment process, such as with live meetings and interviews.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network, in an example embodiment.

FIG. 2 is a depiction of a recruitment network including a recruiter and users of the social network who are recruitment prospects, in an example embodiment.

FIG. 3 is a graph depicting the plotting of the relevance of users to a recruitment search query and a likelihood of interaction with a communication, in an example embodiment.

FIG. 4 is a flowchart for recruiter searching using multi-objective optimization in a social network, in an example embodiment.

FIG. 5 is a block diagram illustrating components of a machine able to read instructions from a machine-readable medium.

### DETAILED DESCRIPTION

Example methods and systems are directed to recruiting multi-objective optimization. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Recruiters may, however, have to attempt to communicate with many prospects in order to receive even a few interactions with prospects. The process of identifying enough such prospects to obtain a desired number of interactions may be time consuming. Even attempting to communicate with certain prospects may be a waste of time; a prospect who is an excellent fit for a position may be totally uninterested in taking the position or leaving a current position.

A system and method have been developed that utilize multi-objective optimization techniques to attempt to identify prospects for a position who are both matches for the requirements of the position and likely to respond to communications. The system and method may factor in both profile data of candidates as well as the candidates activities on the social network. Such activities may be indicative of overall engagement by the candidate on the social network and a form of communication that is most likely to produce a response.

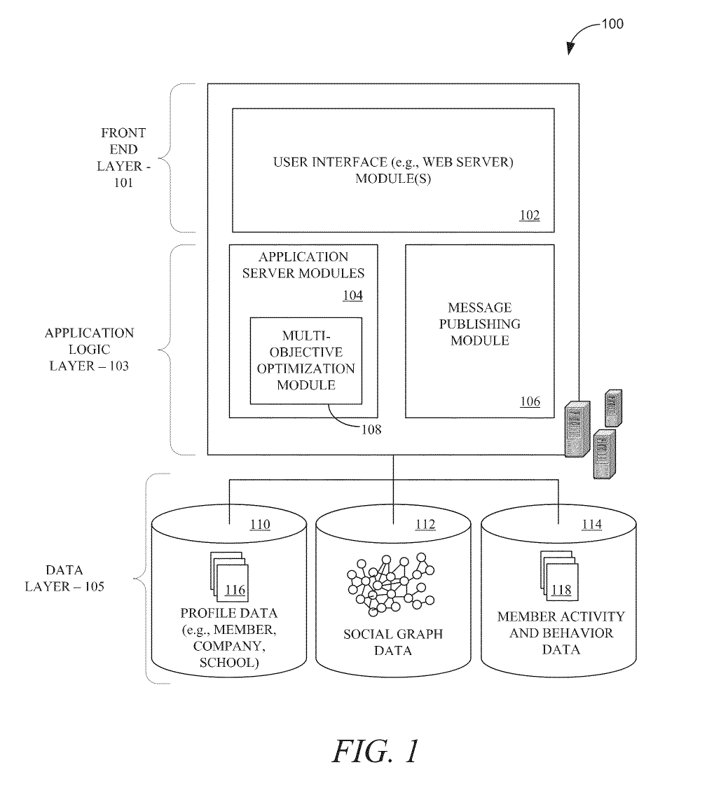

FIG. 1 is a block diagram illustrating various components or functional modules of a social network 100, consistent with some examples. The social network 100 may be utilized to provide treaded electronic messages within the user interface of the social network 100. While the threading of electronic messages are described with particular respect to the social network 100, it is to be recognized and understood that the principles described with respect to threaded electronic messages may be applied to any of a variety of platforms and electronic messages beyond those directly applicable to a social network generally.

A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network 100 includes a content item publishing module 106, such as may be utilized to receive content, such as electronic messages, posts, links, images, videos, and the like, and publish the content to the social network.

One or more of the application server modules 104, the content item publishing module 106, or the social network 100 generally may include a multi-objective optimization module 108. As will be disclosed in detail herein, the multi-objective optimization module 108 may identify prospects for a position. The multi-objective optimization module 108 may both compare profile data from the data layer 105 with characteristics of a recruitment search query as well as consider member activity and behavior data from the data layer 105 to identify a likelihood that various users will interact with a communication related to the position. The recruitment search query may include search terms, including characteristics of or from a recruitment profile related to the position; as such, in various examples, the recruitment search query may be recruiter-entered keywords or search terms or may be derived directly from characteristics of a recruitment profile that the recruiter may submit. The results from the multi-objective optimization module 108 may be utilized by, for instance, application service modules 104 to provide recommended users for a position to a recruiter and facilitate communications between the recruiter and identified and/or selected users.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network 100 may be logged as activities 118 in the activity and behavior database 114. Such activities may include communication with others via the social network, engagement with content items posted on the social network, joining groups, following entities, and so forth. Such activities may be accessed, such as to assess overall engagement by the members to which the activities 118 correspond.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations.

Although not shown, with some examples, the social network 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

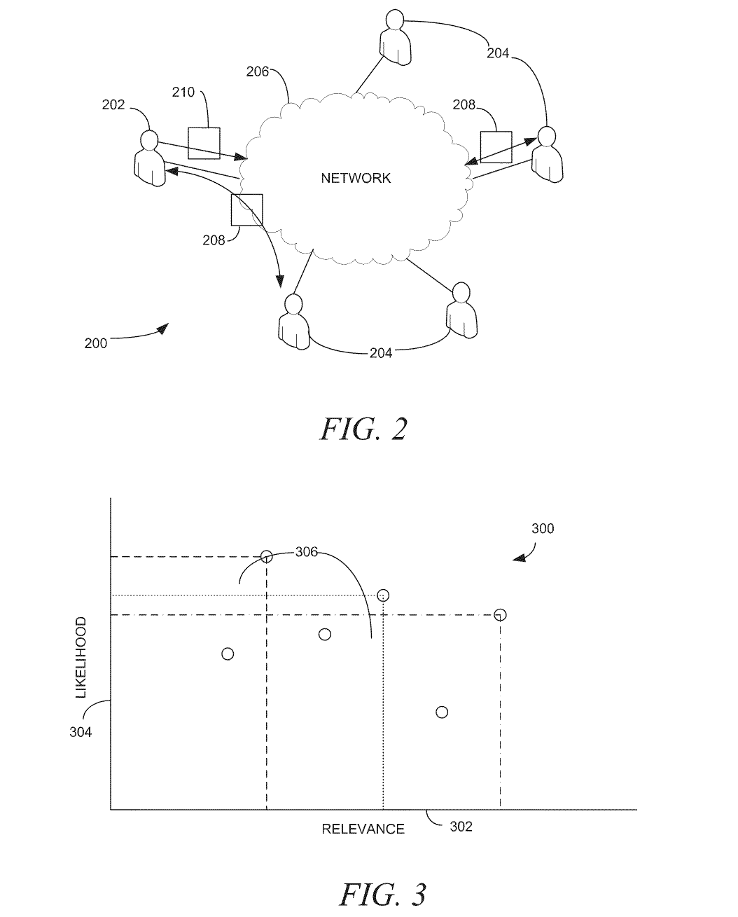

FIG. 2 is a depiction of a recruitment network 200 including a recruiter 202 and users 204 of the social network who are recruitment prospects, in an example embodiment. The recruiter 202 and users 204 are depicted as people, but it is to be readily understood that the recruiter 202 and users 204 may utilize user devices, such as personal computers, mobile devices, tablet computers, and the like. Additionally, at least the recruiter 202 may be an automated entity and may not necessarily involve human intervention for some or all of the activities or operations described herein.

The recruitment network 200 includes a communication network 206 over which the recruiter 202 and users 204 may communicate with each other and with the social network 100. The social network 100 may be part of the communication network 206 or may be coupled to the communication network 206. The users 204 may be users of the social network 100 or members of the social network 100. The recruiter 202 may be a user or member of the social network 100 but is not necessarily either a user or a member.

The network 206 may facilitate communications 208 between and among the entities in the recruitment network 200. Communications 208 may be transmitted from the recruiter 202 to the users 204 and vice versa. Communications 208 may also originate from the social network 100 and be transmitted to the recruiter 202 or to one or more users 204. Additionally or alternatively, the communications 208 may include a communication to the recruiter 202 about the users 204, such as a ranked list of the users according to a multi-objective optimized recruiter search, as disclosed herein.

A communication 208 may elicit another communication 208 in response. A user 204 may be said to have interacted with a communication 208 by transmitting a communication 208 in return. A communication 208 may be any of a variety of electronic communications, including electronic messages, electronic mail, text messages, and any other type of electronic or network communication known in the art.

Each individual user 204 may have individual database entries 116, 118 in the data layer 105 associated with that individual user 204. Thus, for each user 204, profile data 116 and activities 118 descriptive of that individual user 204 may be accessed. The multi-objective optimization module 108 may utilize those entries 116, 118 from each individual user 204 to determine whether each individual user 204 should or show not be communicated with, as disclosed herein.

The multi-objective optimization module 108 may receive a recruitment search query 210 from the recruiter. The recruitment search query 210 may be or may include search terms, such as keywords, and/or a recruitment profile. The recruitment profile may include one or more recruitment characteristics. For instance, the recruitment profile may specify that a user 204 variously may, should, or must have certain characteristics to qualify for a position associated with the recruitment profile. Thus, in an example, the recruitment profile may specify that a user 204 must have a particular educational degree, should have a predetermined number of years in a particular field, and may be willing to live and work in a particular geographical area, among any of a variety of potential criteria for being accepted for the position.

As such, the recruitment profile may establish various degrees of importance to individual criteria. Individual criteria may be conditions precedent on considering a user (“must”), may be a strong preference but not required (“should”), may be preferred but not strongly (“may”), and so forth. The recruitment profile may utilize language keys as disclosed herein or may numerically weight individual criteria. Thus, certain criteria may be given a high weight (e.g., ten out of ten) while other criteria may be given middle to low weight.

The multi-objective optimization module 108 may obtain, for each of the users 204, a comparison of the individual users 204 profile data 116 against the recruitment search query 210. The comparison may include a variety of mechanisms for indicating a degree to which each individual user 204 matches the recruitment search query 210. For instance, the comparison may produce a number value of a number of the recruitment profile characteristics that are met by a given user 204. The comparison may produce a weighted number value, in which characteristics with high weight that are met by a user 204 are given a high value, such as the weight itself. Thus, if a given user 204 matches a level “10” weighted criterion, a level “7” weighted criterion, and a level “3” weighted criterion, the given user 204 may have a profile match value of twenty (20). Additional comparison mechanisms are contemplated, such as how well a given user 204 matches various criteria. Thus, if a criterion is for a degree in electrical engineering but a user 204 has a degree in computer engineering the user 204 may be given some but not all of the value of the criterion, e.g., “4” rather than a maximum of “6”. The recruitment profile may specify such partial awards.

The multi-objective optimization module 108 may further determine a likelihood of each individual user 204 to interact with a communication 208 regarding the position associated with the recruitment search query 210 search terms and/or the recruitment profile. The multi-objective optimization module 108 may factor in any characteristic from the profile data 116 and the activities 118 of each individual user 204 to determine the likelihood for that user 204 to interact with a communication 208.

In an example, the activities 118 may reflect the percentage of previous communications 208 the associated user 204 has interacted with. The activities 118 may further reflect a percentage of a variety of types of communications 208 the associated user 204 has interacted with. Thus, for instance, a given user 204 may interact with one-third of communications 208 that are received via a message through the social network 100 itself but may interact with three-quarters of communications 208 that are received via the user's 204 personal email account.

The multi-objective optimization module 108 may further factor in profile data 116 and activities 118 that indicate that given users 204 are looking for a new position or may be interested in a new position. For instance, a user 204 whose activities 118 include viewing job postings or visiting recruitment websites may have a relatively high likelihood of responding to a communication 208 related to the position, while a user 204 whose activities 118 do not include such visits may have a relatively low likelihood. Similarly, a user who affirmatively changes a profile status in their profile data 116 to looking for a new position or interested in being contacted for a new position may have a higher likelihood of an interaction than a user 204 who does not so indicate.

Thus, the likelihood of interaction may be based on various general factors. A user 204 may have a high likelihood if the user 204 is likely interested in obtaining a new position at all and without respect to the position associated with the recruitment profile. A user 204 may have a high likelihood if the user 204 is likely interested in the position associated with the recruitment profile itself, such as when the activities 118 suggest an interest in the position (e.g., a user 204 who follows NASA on the social network 100 may be more likely to interact with a communication 208 regarding a position in the aerospace industry). A user 204 may have a high likelihood if the user 204 has relatively high engagement on the social network 100 (e.g., accessing and posting content and so forth) or a propensity to engage with other communications 208.

Each factor in the likelihood of interaction described above may be given a numerical value associated with the factor and/or a percentage likelihood of that factor in isolation. Certain factors may be weighted higher than others or all of the factors may be cumulative. The overall likelihood of interaction may be a cumulative score of the various factors or may reflect the various percentages, such as according to the preferences established in the recruitment search query 210.

For instance, a recruitment search query 210 may be relatively selective and may base the likelihood off of the least likely factor. Thus, if a particular user 204 has two factors that suggest high likelihood of interaction but one factor that suggests a high likelihood then the low likelihood may override the high likelihoods in determining the overall likelihood of the user 204 to interact. The inverse may also be selected. Thus, if two factors suggest a low likelihood but one suggests a high likelihood then the user 204 may be assessed as having a high likelihood overall.

FIG. 3 is a graph 300 depicting the plotting of the relevance of users 204 to a recruitment search query 210 and a likelihood of interaction with a communication 208, in an example embodiment. The relevance is depicted on the X-axis 302 and the likelihood of interaction is depicted on the Y-axis 304. The graph 300 is merely illustrative and is not necessarily generated in order to determine which users 204, if any, will receive a communication 208 regarding the position.

Users 204 may not be considered for a communication 208 at all if the user 204 in question does not meet one or more required criteria of the recruitment search query 210. Thus, if a given user 204 does not meet a “must” condition then the user 204 may not be eligible for a communication 208 and may not be depicted on the physical graph 300. In examples where a “must” condition is not included in the recruitment search query 210 then all of the considered users 204 may be included in the graph 300.

In general, the users 204 that have the largest area under a rectangle 306 defined by the coordinate of the user 204 on the graph 300 may be deemed to have the optimal conditions for both meeting the recruitment search query 210 criteria and likelihood to interact. The multi-objective optimization module 108 may identify one or more users 204 that have a highest area 306 and thus may combine the best fit with the recruitment profile characteristics and the likelihood to interact. The recruitment search query 210 may specify a number of users 204 that may be identified to receive a communication 208, may specify a minimum area 306 and any user 204 that exceeds the minimum area 306 may be identified to receive a communication, and so forth.

Additionally, where the communication 208 is a ranked list of users 204 as generated by the multi-objective optimization module 108, the users 204 may be ranked according to the users' corresponding areas 306. As such, the ranked list may rank the users 204 from a user 204 with a highest area 306 on down. The multi-objective optimization module 108 may include a predetermined number of users 204 to be ranked or may receive a predetermined number of users from the recruitment search query 210 or recruitment profile.

The recruitment search query 210 may specify minimum levels of one or both axes 302, 304. Thus, the recruitment search query 210 may require a minimum match between the profile data 116 and the recruitment profile and/or a minimum likelihood to interact. A user 204 that does not meet one or both minima may not be selected to receive a communication 208 regardless of if the area 306 would otherwise suggest that the user 204 should receive a communication 208.

The communication 208 may be transmitted automatically by the social network 100 to users 204 that meet the criteria. The communication 208 may be included with or as part of the recruitment profile. Alternatively, the multi-objective optimization module 108 may rank or otherwise sort the users 204 according to their associated area 306 and present some or all of the users 204 according to rank to the recruiter 202, whereupon the recruiter may initiate the communication 208, either automatically or based on human interaction.

The format of the communication 208 may be dynamically selected for each of the users 204 based on the activities 118 for each individual user 204. In various examples, the format for the communication 208 for each individual user 204 may be selected based on each user's 204 individual propensity to interact with communications 208 in the particular format. Such dynamic selection may be made automatically or may take the form of a recommendation to the recruiter 202. Alternatively, communications 208 may be according to a specified format.

If a user 204 who has been sent a communication 208 does not interact with the communication 208, a second communication 208 may be transmitted. In various examples, the second communication 208 may be in an alternative format different from the format of the first communication 208. The recruiter 202 may be consulted before transmitting the second communication 208, e.g., so that the recruiter 202 may approve or reject the transmission of the second communication 208.

In various examples, the multi-objective optimization module 108 may return a predetermined number of the users 204 who have the best results, e.g., the greatest area 306 and who meet the necessary requirements. In various examples, the multi-objective optimization module 108 may return all users 204 to meet a predetermined minimum condition. In various examples, the multi-objective optimization module 108 may return a ranked list of some or all of the users 204 to the recruiter 202 for the recruiter to manually evaluate and select users 204 to receive communications 208.

### Flowchart

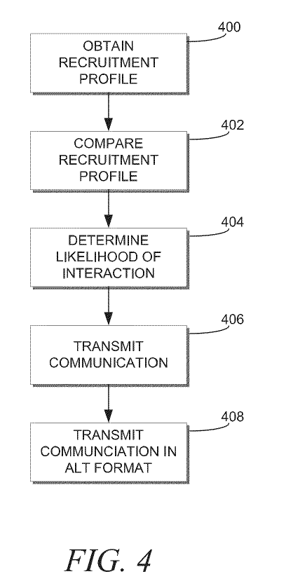

FIG. 4 is a flowchart for recruiter searching using multi-objective optimization in a social network, in an example embodiment. The flowchart may be performed with any of a variety of devices and systems disclosed herein, as well as with any suitable system known in the art.

At operation 400, a recruitment search query for a position in an organization is obtained.

At operation 402, the recruitment search query is compared against profile data from a social network of at least some of a plurality of users to obtain a comparison, the profile data being stored in a database. In an example, the profile data of one of the plurality of users includes a current relationship and wherein the activities of the one of the plurality of users are indicative of a likelihood of the one of the plurality of users to end the current relationship. In an example, the current relationship is an employment relationship. In an example, the profile data for each of the plurality of users includes a plurality of individual characteristics of an associated one of the plurality of users user and the recruitment search query includes a plurality of profile characteristics related to the position, and wherein the comparison is based, at least in part, on a relationship of ones of the plurality of individual characteristics to ones of the plurality of profile characteristics.

At operation 404, for each of the at least some of the plurality of users, a likelihood of interacting with a recruiter associated with the position is determined based on activities in the social network of each of the at least some of the plurality of users, the activities being stored in the database. In an example, the activities include instances of one of the plurality of users associated with the activities responding to messages and wherein the likelihood of interacting is based, at least in part, on a rate at which the one of the plurality of users has responded to messages. In an example, the activities include instances of one of the plurality of users associated with the activities indicating an interest in receiving the communication. In an example, the interest in receiving the communication includes responses to previous communications. In an example, the profile data of the one of the plurality of users includes a status indicating a desire to be recruited and wherein determining the likelihood of interacting with the recruiter is based on the status.

In an example, the likelihood of interacting is based, at least in part, on a relative number of activities for each individual user, wherein the likelihood of a first user to interact is higher than the likelihood of a second user to interact if the first user has more activities than the second user. In an example, the activities are indicative of an interest in the position. In an example, the activities of the at least one of the plurality of users are indicative of a form of communication to which the at least one of the plurality of users is most likely to be responsive, and wherein transmitting the communication is according to the form of communication.

At operation 406, a communication related to the position is transmitted, via a network interface, to at least one of: (1) a recruiter associated with the recruitment search query and (2) one of the plurality of users, a communication related to the position based, at least in part, on the comparison and the likelihood of interacting, wherein the communication is caused to be displayed on a user interface.

At operation 408, the communication is transmitted in an alternative form based on the at least one of the plurality of users not responding to the communication according to the first form of communication. In an example, the form of communication is a first form of communication.

### System

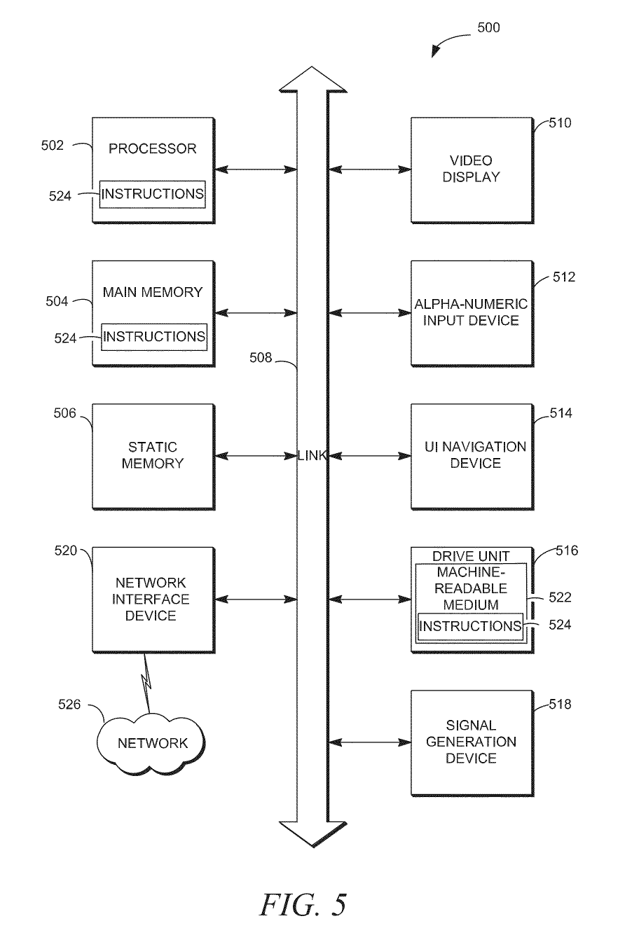

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system and within which instructions 524 (e.g., software) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a graphics display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, during execution thereof by the machine 500. Accordingly, the main memory 504 and the processor 502 may be considered as machine-readable media. The instructions 524 may be transmitted or received over a network 526 via the network interface device 520.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 500), such that the instructions, when executed by one or more processors of the machine (e.g., processor 502), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
obtaining, with a processor, a recruitment search query for a position in an organization;
comparing, with the processor, the recruitment search query against profile data from a social network of at least some of a plurality of users to obtain a comparison, the profile data being stored in a database;
determining, for each of the at least some of the plurality of users, a likelihood of interacting with a recruiter associated with the position based on activities in the social network of each of the at least some of the plurality of users, the activities being stored in the database; and
transmitting, via a network interface, to at least one of: (1) a recruiter associated with the recruitment search query and (2) one of the plurality of users, a communication related to the position based, at least in part, on the comparison and the likelihood of interacting, wherein the communication is caused to be displayed on a user interface.

2. The method of claim 1, wherein the activities include instances of one of the plurality of users associated with the activities responding to messages and wherein the likelihood of interacting is based, at least in part, on a rate at which the one of the plurality of users has responded to messages

3. The method of claim 1, wherein the activities include instances of one of the plurality of users associated with the activities indicating an interest in receiving the communication.

4. The method of claim 3, wherein the interest in receiving the communication includes responses to previous communications.

5. The method of claim 3, wherein the profile data of the one of the plurality of users includes a status indicating a desire to be recruited and wherein determining the likelihood of interacting with the recruiter is based on the status.

6. The method of claim 1, wherein the profile data of one of the plurality of users includes a current relationship and wherein the activities of the one of the plurality of users are indicative of a likelihood of the one of the plurality of users to end the current relationship.

7. The method of claim 1, wherein the likelihood of interacting is based, at least in part, on a relative number of activities for each individual user, wherein the likelihood of a first user to interact is higher than the likelihood of a second user to interact if the first user has more activities than the second user.

8. The method of claim 1, wherein the activities are indicative of an interest in the position.

9. The method of claim 1, wherein the profile data for each of the plurality of users includes a plurality of individual characteristics of an associated one of the plurality of users user and the recruitment search query includes a plurality of profile characteristics related to the position, and wherein the comparison is based, at least in part, on a relationship of ones of the plurality of individual characteristics to ones of the plurality of profile characteristics.

10. The method of claim 1, wherein the activities of the at least one of the plurality of users are indicative of a form of communication to which the at least one of the plurality of users is most likely to be responsive, and wherein transmitting the communication is according to the form of communication.

11. The method of claim 10, wherein the form of communication is a first form of communication and further comprising:
transmitting the communication in an alternative form based on the at least one of the plurality of users not responding to the communication according to the first form of communication.

12. The method of claim 1, wherein transmitting the communication is to the recruiter and wherein the communication is a ranked list of at least some of the plurality of users based, at least in part, on the likelihood of interacting for each of the at least some of the plurality of users.

13. A computer readable medium comprising instructions that, when executed on a processor, cause the processor to implement operations comprising:
obtaining, with a processor, a recruitment search query for a position in an organization;
comparing, with the processor, the recruitment search query against profile data from a social network of at least some of a plurality of users to obtain a comparison, the profile data being stored in a database;
determining, for each of the at least some of the plurality of users, a likelihood of interacting with a recruiter associated with the position based on activities in the social network of each of the at least some of the plurality of users, the activities being stored in the database; and
transmitting, via a network interface, to at least one of: (1) a recruiter associated with the recruitment search query and (2) one of the plurality of users, a communication related to the position based, at least in part, on the comparison and the likelihood of interacting, wherein the communication is caused to be displayed on a user interface.

14. The computer readable medium of claim 13, wherein the activities include instances of one of the plurality of users associated with the activities responding to messages and wherein the likelihood of interacting is based, at least in part, on a rate at which the one of the plurality of users has responded to messages.

15. The computer readable medium of claim 13, wherein the activities include instances of one of the plurality of users associated with the activities indicating an interest in receiving the communication.

16. The computer readable medium of claim 15, wherein the interest in receiving the communication includes responses to previous communications.

17. The computer readable medium of claim 15, wherein the profile data of the one of the plurality of users includes a status indicating a desire to be recruited and wherein determining the likelihood of interacting with the recruiter is based on the status.

18. The computer readable medium of claim 13, wherein the profile data of one of the plurality of users includes a current relationship and wherein the activities of the one of the plurality of users are indicative of a likelihood of the one of the plurality of users to end the current relationship.

19. The computer readable medium of claim 13, wherein the likelihood of interacting is based, at least in part, on a relative number of activities for each individual user, wherein the likelihood of a first user to interact is higher than the likelihood of a second user to interact if the first user has more activities than the second user.

20. The computer readable medium of claim 13, wherein the activities are indicative of an interest in the position.

21. The computer readable medium of claim 13, wherein the profile data for each of the plurality of users includes a plurality of individual characteristics of an associated one of the plurality of users user and the recruitment search query includes a plurality of profile characteristics related to the position, and wherein the comparison is based, at least in part, on a relationship of ones of the plurality of individual characteristics to ones of the plurality of profile characteristics.

22. The computer readable medium of claim 13, wherein the activities of the at least one of the plurality of users are indicative of a form of communication to which the at least one of the plurality of users is most likely to be responsive, and wherein transmitting the communication is according to the form of communication.

23. The computer readable medium of claim 22, wherein the form of communication is a first form of communication and further comprising:
transmitting the communication in an alternative form based on the at least one of the plurality of users not responding to the communication according to the first form of communication.

24. The computer readable medium of claim 13, wherein transmitting the communication is to the recruiter and wherein the communication is a ranked list of at least some of the plurality of users according to the likelihood of interacting.
